(19) United States
(12) Patent Application Publication
(10) Pub. No.: US 2016/0127445 A1
(43) Pub. Date: May 5, 2016

(54) METHODS AND DEVICES FOR IDENTIFYING TERMINAL

(71) Applicant: Xiaomi Inc., Beijing (CN)

(72) Inventors: Jianrong SHEN, Beijing (CN); Guobin TAN, Beijing (CN); ZHE MA, Beijing (CN)

(73) Assignee: Xiaomi Inc., Beijing (CN)

(21) Appl. No.: 14/856,247

(22) Filed: Sep. 16, 2015

Related U.S. Application Data
(63) Continuation-in-part of application No. PCT/CN2015/075023, filed on Mar. 25, 2015.

(30) Foreign Application Priority Data
Oct. 31, 2014 (CN) 201410602432.X

(51) Int. Cl. H04L 29/08; H04L 29/06

(52) U.S. Cl. CPC H04L 67/02; H04L 67/2857; H04L 67/42

(57) ABSTRACT

Methods and devices are provided for identifying a terminal. In the method, the device receives a request for accessing a target webpage sent by the terminal. The device sends preset drawing information to the terminal, where the preset drawing information may instruct the terminal to draw a corresponding object according to the preset drawing information. The device acquires object information for characterizing the object drawn by the terminal and generates identification information for identifying the terminal according to the object information.

### CROSS-REFERENCE TO RELATED APPLICATIONS

This application is a Continuation-in-part application of International Application No. PCT/CN2015/075023, filed Mar. 25, 2015, which is based upon and claims priority to Chinese Patent Application No. CN201410602432.X, filed Oct. 31, 2014, the entire contents of all of which are incorporated herein by reference.

### TECHNICAL FIELD

The present disclosure relates to the field of Internet technology, and more particularly, to a method and a device for identifying a terminal.

### BACKGROUND

In order to provide a more highly personalized service for a user, websites will typically generate identification information for a terminal to identify the terminal by the identification information.

One conventional method for identifying a terminal includes: when the terminal accesses a certain website for a first time, a server of the website generates identification information corresponding to the terminal, and sends a cookie (a small text file) which carries the identification information to the terminal. Then, when the terminal accesses the terminal again, the terminal may send the cookie to the server, and the server identifies the terminal by the identification information in the received cookie.

### SUMMARY

According to a first aspect of embodiments of the present disclosure, a method for identifying a terminal is provided. The method includes: receiving a request for accessing a target webpage sent by the terminal; sending preset drawing information to the terminal, the preset drawing information for instructing the terminal to draw a corresponding object according to the preset drawing information; acquiring object information for characterizing the object drawn by the terminal; and generating identification information for identifying the terminal according to the object information.

According to a second aspect of the embodiments of the present disclosure, a device for identifying a terminal is provided. The device includes: a processor and a memory for storing executable instructions by the processor. The processor is configured to: receive a request for accessing a target webpage sent by the terminal; send preset drawing information to the terminal, the preset drawing information for instructing the terminal to draw a corresponding object according to the preset drawing information; acquire object information for characterizing the object drawn by the terminal; and generate identification information for identifying the terminal according to the object information.

According to a third aspect of embodiments of the present disclosure, a non-transitory computer readable storage medium is provided, when instructions in the storage medium are executed by a processor of a server, the server is caused to execute the following steps: receiving a request for accessing a target webpage sent by the terminal; sending preset drawing information to the terminal, the preset drawing information for instructing the terminal to draw a corresponding object according to the preset drawing information; acquiring object information for characterizing the object drawn by the terminal; and generating identification information for identifying the terminal according to the object information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for identifying a terminal according to an exemplary embodiment.

FIG. 2 is a flow chart of a method for identifying a terminal according to another exemplary embodiment.

FIG. 3 is a block diagram of a device for identifying a terminal according to an exemplary embodiment.

FIG. 4 is a block diagram of a device for identifying a terminal according to another exemplary embodiment.

FIG. 5 is a block diagram of a device for identifying a terminal according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects associated to the invention as recited in the appended claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

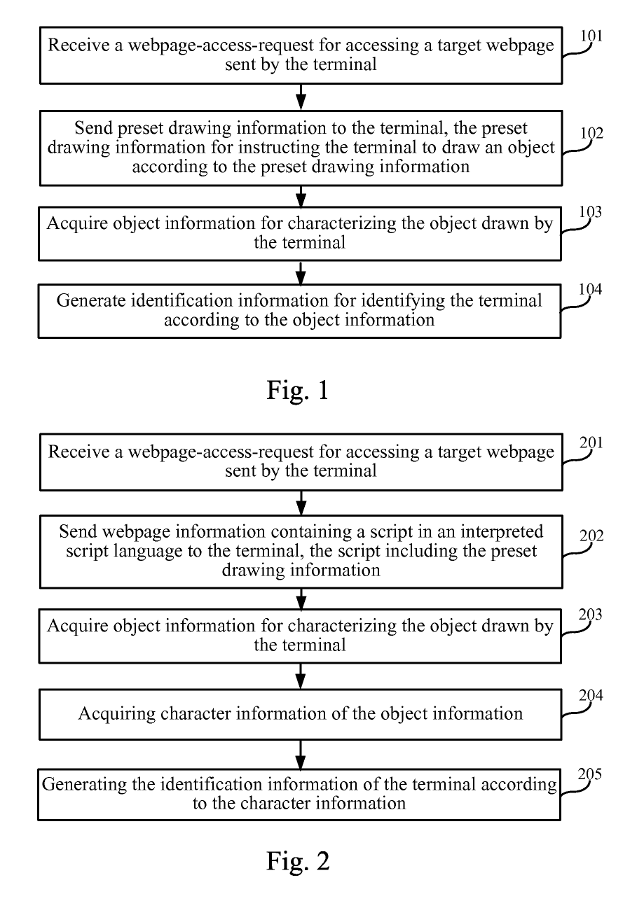

FIG. 1 is a flow chart of a method for identifying a terminal according to an exemplary embodiment. The method may be at least partially implemented by a server computer. The method may also be at least partially implemented by other computing devices. As shown in FIG. 1, the method for identifying the terminal may include the following steps.

In step 101, a webpage-access-request for accessing a target webpage sent by the terminal is received. The user may operate a user terminal to send a webpage-access-request for accessing the target webpage to a server or other computing devices.

In step 102, preset drawing information is sent to the terminal, the preset drawing information for instructing the terminal to draw a corresponding object according to the preset drawing information. The preset drawing information may include at least one of a picture, an animation, a video, or other types of picture related information.

In step 103, object information for characterizing the object drawn by the terminal is acquired. The object information may be determined based on the different hardware in the terminal. Thus, the object information may characterize the terminal like a person's fingerprint.

In step 104, identification information for identifying the terminal is generated according to the object information.

Accordingly, in the method for identifying the terminal provided by embodiments of the present disclosure, preset drawing information is sent to the terminal after a webpage-access-request sent by the terminal is received, and the terminal draws a corresponding object according to the preset draw information; object information for characterizing the object drawn by the terminal is acquired; identification information for identifying the terminal is generated according to the object information. Thus, it may be solved the problem in the related art that a sever cannot identify the terminal when the cookie which carries the terminal identification information is shielded by the terminal; and it may be achieved the effect that the identification information of the terminal may be generated dynamically, so it is always possible to identify the terminal.

FIG. 2 is a flow chart of a method for identifying a terminal according to an exemplary embodiment. The method may be at least partially implemented by a server computer. As shown in FIG. 2, the method for identifying the terminal may include the following steps.

In step 201, a webpage-access-request for accessing a target webpage sent by the terminal is received.

When a user intends to access a target webpage via a terminal, the user may operate the terminal to send a webpage-access-request for accessing the target webpage to a server. Correspondingly, the server may receive the webpage-access-request sent by the terminal.

In step 202, webpage information containing a script in an interpreted script language s sent to the terminal, the script may carry the preset drawing information. The interpreted script language may include JavaScript, AppleScript, Python, VBScript, Perl, and etc.

After the server receives the webpage-access-request sent by the terminal, the server may send webpage information containing a JavaScript script to the terminal, the JavaScript script carrying the preset drawing information. Wherein, the preset drawing information is for instructing the terminal to draw a corresponding object according to the preset drawing information. Different terminals will draw different objects according to the preset drawing information and the object drawn by the terminal according to the preset drawing information may be at least one of a picture, an animation and a video, which is not limited in the disclosure.

After the server sends the webpage information to the terminal, the terminal may receive the webpage information sent by the server correspondingly, and draws a corresponding object according to the preset drawing information carried in the JavaScript script in the received webpage information.

In the disclosure, the preset drawing information is information for instructing the terminal to draw a corresponding picture, for example. The server may send the webpage information containing a JavaScript script to the terminal which carries Canvas codes. Since configuration information of different terminals may be different, the configuration information of the terminal including at least one of a graphic processing engine employed by the browser in the terminal, a picture export employed by the browser, a default compression level employed by the browser, a setting for anti-aliasing and sub-pixel render operation employed by the operating system of the terminal, an algorithm of a setting for anti-aliasing and sub-pixel render operation employed by the operating system of the terminal, and a video card employed by the terminal. Eave if one item in the configuration information is different, pictures drawn by the terminals according to the Canvas codes will be different. Therefore, in practical implementing, different terminals may draw different pictures according to the Canvas codes. Even though the terminals are of a same type in a same manufactured batch, the resulting drawn pictures may be different due to different serial numbers of the video cards in the terminals.

It should be noted that, in the disclosure, the server instructs the terminal to draw pictures according to Canvas codes for example. In practical implementing, the server may also instruct the terminal to draw pictures according to codes of other types, as long as different terminals may draw different pictures according to the code. This is not limited in the disclosure.

It should be further noted that, since Canvas codes apply to an HTML5 (Hyper Text Markup Language) website and a website of a version superior to HTML5, the target webpage in the disclosure that the terminal requests to access is a webpage in an HTML5 website or a website of a version superior to HTML5.

In step 203, object information for characterizing the object drawn by the terminal is acquired.

After the server sends the preset drawing information to the terminal, the server may acquire the picture information for characterizing the picture drawn by the terminal from the terminal.

In practical implementing, the server may acquire the picture information of the picture drawn by the terminal in a Portable Network Graphic (PNG) format. For example, the terminal may acquire a base64 coded string which is returned by the terminal and for characterizing the pattern of the picture.

It should be noted that, in the disclosure, the server acquires the picture information of the picture in a PNG format for example. In practical implementing, the server may also acquire the picture information of the picture in other formats, which is not limited in the disclosure. The other picture formats may include JPEG, Animated Portable Network Graphics (APNG), Multiple-image Network Graphics (MNG), JPEG Network Graphics (JNG), etc.

In step 204, character information of the object information is acquired.

After the server acquires the picture information of the picture, in order to perform the subsequent steps, the server may acquire the character information of the picture information.

In practical implementing, the server may acquire the character information of the picture information in the following manners.

In a first manner, when the object is a picture and the object information is picture information acquired in a PNG format, a check code in the object information is extracted and the check code is taken as the character information.

Since the picture information acquired in a PNG format contains a check code, and different picture patterns correspond to different check codes, the server may acquire the check code in the picture information, and then take the acquired check code as the character information.

Since each data block of the picture information acquired in a PNG format has a check code, in order to reduce the processing complexity of the server, the server may extract the 32-bit check code in the last data block and take the extracted 32-bit check code as the character information. Alternatively or additionally, the server may also select a random data block from the picture file to extracted 32-bit check code as the character information. By using only a portion of the image, the method reduces the processing time required by the server.

In a second manner, a hash value of the object information is calculated through a preset hash algorithm, and the hash value is taken as the character information.

Since different terminals may draw different pictures according to the preset drawing information, the server may also simply calculate the hash value of the acquired picture information through a preset hash algorithm, and then simply take the calculated hash value as the character information.

It should be noted that, in the disclosure, the character information is acquired in the above manners for example. In practical implementing, the server may also acquire the character information in other manners. For example, a hash value of the acquired check code is calculated through a hash algorithm and the calculated hash value is taken as the character information and so on, as long as the acquired character information may be employed to distinguish different pictures, that is, the character information of different pictures is different. The acquisition methods are not limited in the disclosure.

In step 205, identification information for identifying the terminal is generated according to the character information.

After the server acquires the character information, the server may generate identification information for identifying the terminal according to the character information. Additionally or alternatively, the server may obtain other specific information from the terminal and generate identification information by combining both the specific information and character information. The specific information may include hardware information, log-on information, or other types of information related to the hardware or software of the terminal.

In practical implementing, the terminal may simply take the extracted character information as the identification information of the terminal.

When the terminal accesses the webpage each time, the server may generate the identification information of the terminal dynamically, and the server may generate the same identification information each time for the same terminal, so the server may identify the terminal by the identification information generated each time.

Accordingly, in the method for identifying the terminal provided by embodiments of the present disclosure, preset drawing information is sent to the terminal after a webpage-access-request sent by the terminal is received, and the terminal draws a corresponding object according to the preset draw information; object information for characterizing the object drawn by the terminal is acquired; identification information for identifying the terminal is generated according to the object information. Thus, it may be solved the problem in the related art that a sever cannot identify the terminal when the cookie which carries the terminal identification information is shielded by the terminal; and it may be achieved the effect that the identification information of the terminal may be generated dynamically, so it is always possible to identify the terminal.

In addition, in the disclosure, the preset drawing information which is carried in the JavaScript script is sent to the terminal, such that the terminal cannot shield the preset drawing information (since the JavaScript script is for generating a dynamic webpage, if the terminal shields the JavaScript script, the webpage will not operate normally, so the terminal usually will not shield the JavaScript script). Thus, it may be ensured that the server may always generate the identification information of the terminal dynamically and then identify the terminal according to the generated identification information.

It should be noted that, if the terminal does not shield cookies, that is, the terminal supports cookies, after the terminal generates the identification information, the server may send a cookie which carries the identification information to the terminal; the terminal receives the cookie sent by the server correspondingly and caches the received cookie. Afterwards, when the terminal accesses the server again, the terminal may send the cached cookie to the server. In this way, when the terminal accesses the server again, the server does not need to generate the identification information of the terminal again, which reduces the processing complexity of the server.

It should be further noted that, the server may also perform the following steps after the server receives the webpage-access-request sent by the server.

Firstly, it is detected whether the webpage-access-request carries a small text file cookie which carries the identification information of the terminal.

Since when the terminal accesses the webpage in a certain website previously, the server may send a cookie which carries the identification information of the terminal to the terminal, and the terminal caches the received cookie and sends the cookie to the server when the terminal accesses the webpage in the website afterwards. Therefore, after the server receives the webpage-access-request sent by the terminal, the server may detect whether the received webpage-access-request carries the cookie which carries the identification information of the terminal.

Secondly, if the webpage-access-request does not carry the cookie, the server may perform an operation of sending the preset drawing information to the terminal.

If a detecting result of the server is that the webpage-access-request does not carry the cookie, to identify the terminal afterwards, the server may perform an operation of sending the preset drawing information to the terminal.

Otherwise, if a detecting result of the server is that the webpage-access-request carries the cookie, then the server may identify the terminal directly according to the identification information in the cookie. Then the process is finished. The embodiments will not repeatedly illustrate herein.

The following is the device embodiment of the present disclosure and may be used to perform the method embodiment of the present disclosure. For the undisclosed detail in the device embodiment of the present disclosure, please refer to the method embodiment of the present disclosure.

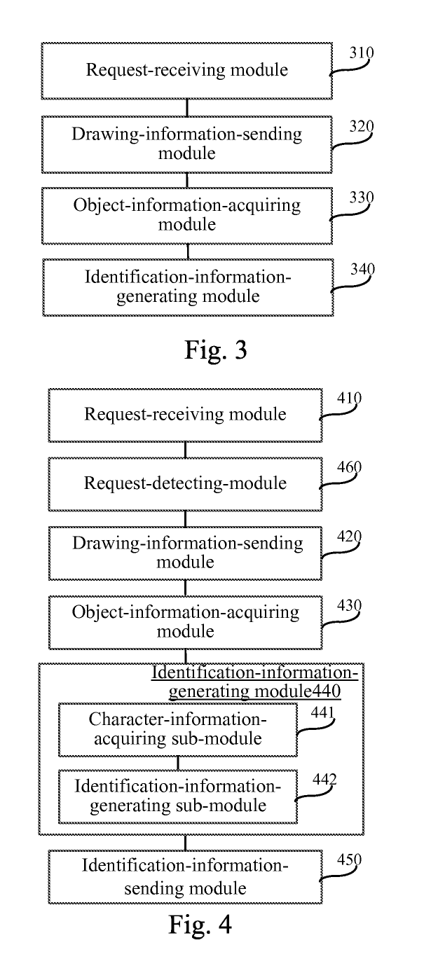

FIG. 3 is a block diagram of a device for identifying a terminal according to an exemplary embodiment. As shown in FIG. 3, the device for identifying a terminal may include, but not limited to, a request-receiving module 310, a drawing-information-sending module 320, an object-information-acquiring module 330 and an identification-information-generating module 340.

The request-receiving module 310 is configured to receive a webpage-access-request for accessing a target webpage sent by the terminal;

the drawing-information-sending module 320 is configured to send preset drawing information to the terminal, the preset drawing information for instructing the terminal to draw a corresponding object according to the preset drawing information;

the object-information-acquiring module 330 is configured to acquire object information for characterizing the object drawn by the terminal; and

the identification-information-generating module 340 is configured to generate identification information for identifying the terminal according to the object information.

Accordingly, in the device for identifying the terminal provided by embodiments of the present disclosure, preset drawing information is sent to the terminal after a webpage-access-request sent by the terminal is received, and the terminal draws a corresponding object according to the preset draw information; object information for characterizing the object drawn by the terminal is acquired; identification information for identifying the terminal is generated according to the object information. Thus, it may be solved the problem in the related art that a sever cannot identify the terminal when the cookie which carries the terminal identification information is shielded by the terminal; and it may be achieved the effect that the identification information of the terminal may be generated dynamically, so it is always possible to identify the terminal.

FIG. 4 is a block diagram of a device for identifying a terminal according to another exemplary embodiment. As shown in FIG. 4, the device for identifying a terminal may include, but not limited to, a request-receiving module 410, a drawing-information-sending module 420, an object-information-acquiring module 430 and an identification-information-generating module 440.

The request-receiving module 410 is configured to receive a webpage-access-request for accessing a target webpage sent by the terminal;

the drawing-information-sending module 420 is configured to send preset drawing information to the terminal, the preset drawing information for instructing the terminal to draw a corresponding object according to the preset drawing information;

the object-information-acquiring module 430 is configured to acquire object information for characterizing the object drawn by the terminal; and

the identification-information-generating module 440 is configured to generate identification information for identifying the terminal according to the object information.

Alternatively or additionally, the drawing-information-sending module 420 is configured to send webpage information containing an interpreted script language JavaScript script to the terminal, the JavaScript script carrying the preset drawing information.

Alternatively or additionally, the identification-information-generating module 440 includes: a character-information-acquiring sub-module 441 configured to acquire character information of the object information; and an identification-information-generating sub-module 442 configured to generate the identification information of the terminal according to the character information.

Alternatively or additionally, the character-information-acquiring sub-module 441 is configured to, when the object is a picture and the object information is information acquired in a PNG format, extract a check code in the object information and take the check code as the character information.

Alternatively or additionally, the character-information-acquiring sub-module 441 is configured to calculate a hash value of the object information through a preset hash algorithm, and take the hash value as the character information.

Alternatively or additionally, the device further includes: an identification-information-sending module 450 configured to, if the terminal supports small text files cookies, send a cookie which carries the identification information to the terminal; the terminal is configured to cache the cookie and send the cookie to the sever when it accesses a sever afterwards.

Alternatively or additionally, the device further includes: a request-detecting-module 460 configured to detect whether the webpage-access-request carries a small text file cookie which carries the identification information of the terminal. The drawing-information-sending module 420 is configured to preform an operation of sending the preset drawing information to the terminal if a detecting result of the request-detecting-module is that the webpage-access-request does not carry the cookie.

Accordingly, in the device for identifying the terminal provided by embodiments of the present disclosure, preset drawing information is sent to the terminal after a webpage-access-request sent by the terminal is received, and the terminal draws a corresponding object according to the preset draw information; object information for characterizing the object drawn by the terminal is acquired; identification information for identifying the terminal is generated according to the object information. Thus, it may be solved the problem in the related art that a sever cannot identify the terminal when the cookie which carries the terminal identification information is shielded by the terminal; and it may be achieved the effect that the identification information of the terminal may be generated dynamically, so it is always possible to identify the terminal.

The disclosure sends the preset drawing information which is carried in the Script in JavaScript to the terminal, such that the terminal cannot shield the preset drawing information (Script in JavaScript is for generating dynamic webpages, if the terminal shields the Script in JavaScript, the webpage is almost impossible to run, so the terminal usually will not shield the Script in JavaScript), which guarantees that the server can always generate the identification information of the terminal dynamically and then identify the terminal according to the generated identification information.

As for the device in the above embodiments, the specific implementations for respective modules to perform operations have been described in detail in the embodiments regarding methods, and thus the detailed descriptions thereof will not be provided here.

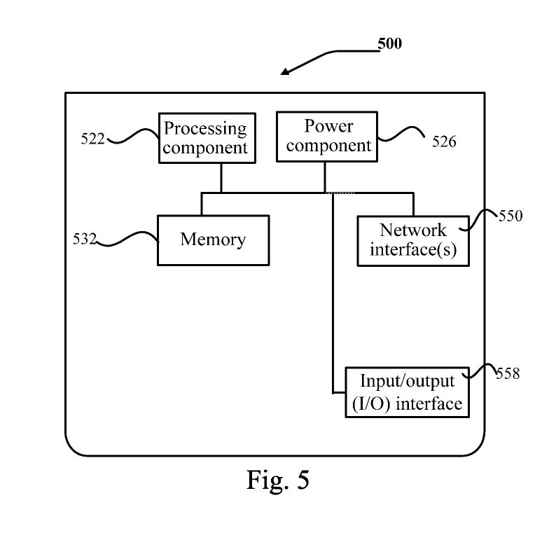

FIG. 5 is a block diagram of a device 500 for identifying a terminal according to an exemplary embodiment. For example, the device 500 may be provided as a server. Referring to FIG. 5, the device 500 includes a processing component 522 that further includes one or more processors, and memory resources represented by a memory 532 for storing instructions executable by the processing component 522, such as application programs. The application programs stored in the memory 532 may include one or more modules each corresponding to a set of instructions. Further, the processing component 522 is configured to execute the instructions to perform the above described method for identifying a terminal.

The device 500 may also include a power component 526 configured to perform power management of the device 500, wired or wireless network interface(s) 550 configured to connect the device 500 to a network, and an input/output (I/O) interface 558. The device 500 may operate based on an operating system stored in the memory 532, such as Windows Server™, Mac OS X™, Unix™, Linux™, FreeBSD™, or the like.

In exemplary embodiments, the device 500 may be implemented by circuitries including one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method for image deletion. The modules and sub-modules may be implemented by the one or more circuitries.

In the present disclosure, the methods and devices solves the following defects exist in the related art: users may disable cookies as users have become more cautious about their personal privacy. Thus, the server cannot identify the terminal according to the identification information using the cookies in the related arts. The methods and devices in the instant application solved the problem when the cookies are shielded by the terminal. It achieves the effect that the identification information of the terminal may be generated dynamically, so it is always possible to identify the terminal.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for identifying a terminal, comprising:
receiving, by a device comprising a processor, a request for accessing a target webpage sent by the terminal;
sending, by the device, preset drawing information to the terminal that instructs the terminal to draw an object according to the preset drawing information;
acquiring, by the device, object information for characterizing the object drawn by the terminal; and
generating, by the device, identification information for identifying the terminal according to the object information.

2. The method according to claim 1, wherein sending preset drawing information to the terminal comprises:
sending webpage information containing a script in an interpreted script language to the terminal, the script comprising the preset drawing information.

3. The method according to claim 1, wherein generating the identification information of the terminal according to the object information comprises:
acquiring character information of the object information; and
generating the identification information of the terminal according to the character information.

4. The method according to claim 3, wherein acquiring the character information of the object information comprises:
when the object is a picture and the object information is information acquired in a Portable Network Graphic (PNG) format, extracting a check code in the object information and taking the check code as the character information.

5. The method according to claim 3, wherein acquiring the character information of the object information comprises:
calculating a hash value of the object information through a preset hash algorithm, and taking the hash value as the character information.

6. The method according to claim 1, further comprising:
if the terminal supports cookies, sending a cookie that carries the identification information to the terminal; the terminal caching the cookie and sending the cookie to a sever when accessing the sever afterwards.

7. The method according to claim 1, wherein the method further comprises:
detecting whether the request carries a cookie that carries the identification information of the terminal; and
if the request does not carry the cookie, preforming an operation of sending the preset drawing information to the terminal.

8. A device for identifying a terminal, comprising:
a processor;
a memory for storing executable instructions by the processor;
wherein the processor is configured to perform:
receiving a request for accessing a target webpage sent by the terminal;
sending preset drawing information to the terminal that instructs the terminal to draw an object according to the preset drawing information;
acquiring object information for characterizing the object drawn by the terminal; and
generating identification information for identifying the terminal according to the object information.

9. The device according to claim 8, wherein sending preset drawing information to the terminal comprises:
sending webpage information containing a script in an interpreted script language to the terminal, the script comprising the preset drawing information.

10. The device according to claim 8, wherein, generating the identification information of the terminal according to the object information comprises:
acquiring character information of the object information; and
generating the identification information of the terminal according to the character information.

11. The device according to claim 8, wherein acquiring the character information of the object information comprises:
when the object is a picture and the object information is information acquired in a Portable Network Graphic (PNG) format, extracting a check code in the object information and taking the check code as the character information.

12. The device according to claim 10, wherein acquiring the character information of the object information comprises:
calculating a hash value of the object information through a preset hash algorithm, and taking the hash value as the character information.

13. The device according to claim 8, wherein the processor is further configured to perform:
if the terminal supports cookies, sending a cookie which carries the identification information to the terminal; the terminal caching the cookie and sending the cookie to a sever when accessing a sever afterwards.

14. The device according to claim 8, wherein the processor is further configured to perform:
detecting whether the request carries a cookie that carries the identification information of the terminal; and
if the request does not carry the cookie, preforming an operation of sending the preset drawing information to the terminal.

15. A non-transitory computer readable storage medium, when instructions in the storage medium are executed by a processor of a server, the server is caused to execute acts comprising:
receiving a request for accessing a target webpage sent by a terminal;
sending preset drawing information to the terminal and instructing the terminal to draw an object according to the preset drawing information;
acquiring object information for characterizing the object drawn by the terminal; and
generating identification information for identifying the terminal according to the object information.

16. The non-transitory computer readable storage medium according to claim 15, wherein sending preset drawing information to the terminal comprises:
sending webpage information containing a script in an interpreted script language to the terminal, the script comprising the preset drawing information.

17. The non-transitory computer readable storage medium according to claim 15, wherein generating the identification information of the terminal according to the object information comprises:
acquiring character information of the object information; and
generating the identification information of the terminal according to the character information.

18. The non-transitory computer readable storage medium according to claim 17, wherein acquiring the character information of the object information comprises:
when the object is a picture and the object information is information acquired in a Portable Network Graphic (PNG) format, extracting a check code in the object information and taking the check code as the character information.

19. The non-transitory computer readable storage medium according to claim 17, wherein acquiring the character information of the object information comprises:
calculating a hash value of the object information through a preset hash algorithm, and taking the hash value as the character information.

20. The non-transitory computer readable storage medium according to claim 15, wherein the server is caused to further execute the following steps:
if the terminal supports cookies, sending a cookie which carries the identification information to the terminal; the terminal caching the cookie and sending the cookie to a sever when accessing a sever afterwards.
